(19) United States
(12) Patent Application Publication
(10) Pub. No.: US 2026/0245310 A1
(43) Pub. Date: Aug. 20, 2026

(54) REMOTE POSE TRANSFER

(71) Applicant: SpreeAI Corporation, Incline Village, NV (US)

(72) Inventors: Minh Phuoc Vo, Alameda, CA (US); Vinh Quang Tran, Woodside, NY (US); Chi Nhan Duong, Quebec (CA); Bo Kyung Kim, Brooklyn, NY (US); Tiffany Seojin Kwak, Lawrenceville, GA (US); Danel Dominguez Sullivan, San Diego, CA (US)

(73) Assignee: SpreeAI Corporation, Incline Village, NV (US)

(21) Appl. No.: 19/056,487

(22) Filed: Feb. 18, 2025

(51) Int. Cl. G06T 19/00; G06T 7/70; G06T 17/20

(52) U.S. Cl. CPC G06T 19/00; G06T 7/70; G06T 17/20; G06T 2200/24; G06T 2207/20081; G06T 2207/20084; G06T 2207/30196; G06T 2210/16

(57) ABSTRACT

In one implementation of remote pose transfer, a processing device receives an input image that depicts a subject person. A pose selection for the subject person and target pose data associated with the pose selection is also received. A first machine-learning model uses the image to determine measurements of the subject person that correlate to one or more dimensions described by the target pose data. A second machine-learning model generates a model of the subject person in the pose of the pose selection based on the measurements of the subject person and the target pose data. The processing device displays a pose-transferred image that depicts the subject person in the pose of the pose selection based on the model of the subject person. In some implementations, a garment selection is also received and is used to depict the subject person in the pose-transferred image wearing the selected garment.

### BACKGROUND

Various types of garments can have different appearances depending on whether the garments are viewed from the front, back, sides, and so forth. For example, garments such as tops or bottoms can have portions shaped to fit more loosely in areas visible from some views, such as from the front or back, and more tightly in areas visible from other views, such as from the sides. Traditionally, individuals have been able to access garments in-person to wear the garments and view how the garments fit from different vantage points using mirrors and/or other fitting aids. However, the increasing trend of individuals acquiring garments online or from remote locations has led to difficulties with assessing how garments may appear while worn. Attempts to address these difficulties include providing access to digital images showing the garments worn by mannequins or human models. However, differences in body shape, height, musculature, and so forth in relation to the mannequins or human models can make it difficult for an individual to visualize how a garment may appear worn on their own body.

### SUMMARY

Techniques and systems for remote pose transfer are described. In one example, a processing device receives an input image that depicts a subject person (e.g., an individual browsing garments online). A pose selection for the subject person and target pose data associated with the pose selection is also received. For example, the person is browsing an online catalog of clothing items and trying to find clothing items (e.g., shirts) that fit well. A first machine-learning model uses the image to determine measurements of the subject person that correlate to one or more dimensions described by the target pose data. A second machine-learning model generates a model of the subject person in the pose of the pose selection based on the measurements of the subject person and the target pose data. The processing device displays a pose-transferred image that depicts the subject person in the pose of the pose selection based on the model of the subject person. In some implementations, a garment selection for the subject person is also received and is used by the processing device to depict the subject person in the pose-transferred image wearing the selected garment.

This Summary introduces a simplified selection of concepts described below in the Detailed Description. As such, this Summary is not intended to identify essential features of the claimed subject matter or to aid in determining its scope.

### BRIEF DESCRIPTION OF THE DRAWINGS

The detailed description is described regarding the accompanying figures. Entities represented in the figures indicate one or more entities; thus, reference is made interchangeably to single or plural forms of the entities in the discussion.

FIG. 1 illustrates a digital medium environment in an example implementation that is operable to employ remote pose transfer techniques as described herein.

FIG. 2 depicts a system in an example implementation that shows the operation of a pose transfer service of FIG. 1 in greater detail, employing the techniques described herein.

FIG. 3 depicts a system in an example implementation showing the operation of modules of the pose transfer service in greater detail.

FIG. 4 depicts a system in an example implementation showing an example operation of an image synthesizing module of the pose transfer service.

FIG. 5 depicts a system and procedure in an example implementation for training a machine-learning model.

FIGS. 6A through 6F depict an example user interface to employ remote pose transfer.

FIG. 7 is a flow diagram depicting an algorithm as a step-by-step procedure in an example implementation of operations performable for accomplishing a result of remote pose transfer.

FIG. 8 illustrates an example system including various components of an example device that can be implemented as any type of computing device as described and/or utilized concerning the previous figures to implement embodiments of the techniques described herein.

### DETAILED DESCRIPTION

### Overview

Ordering garments remotely, such as through a garment provider over the Internet, can be both convenient and frustrating. On one hand, it offers unmatched convenience and the ability to browse numerous options. However, this convenience comes with its fair share of frustrations. For instance, one of the biggest challenges is being unable to physically try on the clothes before purchasing. Some portions of garments can look different when viewed from different angles. This can make it difficult to assess how garments will fit and look while worn and can lead to inconveniences such as returning or exchanging garments, incurring additional costs, and wasting time.

Garment providers and manufacturers often provide sizing charts that display a garment's measurements in different sizes. These charts typically include key measurements like chest, waist, hips, inseam, and/or sleeve length, and indicate which size (e.g., small(S), medium (M), large (L), etc.) corresponds to each range of body measurements. Sizing charts are intended to assist viewers, especially individuals browsing online, with choosing well-fitting clothes. However, sizing charts can be difficult to navigate because sizing varies across brands and body types. Because they generally focus on a few key measurements, sizing charts do not account for other factors like body shape, height, and personal preferences.

In order to provide additional information regarding how garments fit and drape, some garment providers will provide digital images that show garments worn by human models or mannequins. However, even when such images are made available to individuals browsing garments online, it can be difficult for individuals to determine how garments would appear on their own bodies. For instance, digital images may depict a “small” size garment worn by a human model or mannequin, but individuals that typically wear “medium” or “large” size garments may have trouble visualizing how these larger sizes might fit. Additionally, even if a garment provider provides digital images showing different human models or mannequins wearing a garment, differences between the human models or mannequins such as torso size, leg length, shoulder length, and so forth can lead to uncertainties as to how the garment will appear on an individual viewing the garment online. These difficulties can be further complicated when garments are depicted in a single view or a small number of views that poorly depict the shape of the garment from different perspectives.

In contrast, the described techniques for remote pose transfer use machine-learning to determine an individual's dimensions from a single uploaded or saved image of the individual. A machine-learning model generates a subject mesh model that represents the body of the individual in the pose depicted by the image. The subject mesh model is processed along with a target pose data associated with a target pose to generate a pose-transferred mesh model. The pose-transferred mesh model represents the body of the individual in the target pose. The pose-transferred mesh model is processed to generate a pose-transferred image that realistically depicts the individual in the target pose. The pose-transferred mesh model is further employed for depicting a selected garment on the body of the individual in the target pose. For instance, the pose-transferred mesh model can be processed along with a selected garment to generate the pose-transferred image, with the pose-transferred image realistically depicting the individual in the target pose while wearing the selected garment.

In this way, individuals can view how garments would appear on themselves in different poses using a single input image. This can reduce a burden on garment provider systems. For instance, instead of maintaining a large number of digital images in memory or other storage that depict garments worn by human models or mannequins, pose-transferred images that accurately depict how garments would appear on individuals can be generated on-demand. As a result, memory and other system resources typically allocated to maintaining the digital images can be utilized for other operations to increase system performance. Additionally, pose-transferred mesh models may be re-used to generate multiple pose-transferred images depicting a single individual wearing different garments. Thus, the described techniques enable individuals to acquire garments remotely with increased confidence that the garments will fit correctly and have the desired appearance, thereby reducing occurrences of garment returns.

The following discussion describes an example environment that employs the techniques described herein. Example procedures are also described as performable in the example environment and other environments. Consequently, the performance of the example procedures is not limited to the example environment, and the example environment is not limited to the performance of the example procedures.

### Example Remote Pose Transfer Environment

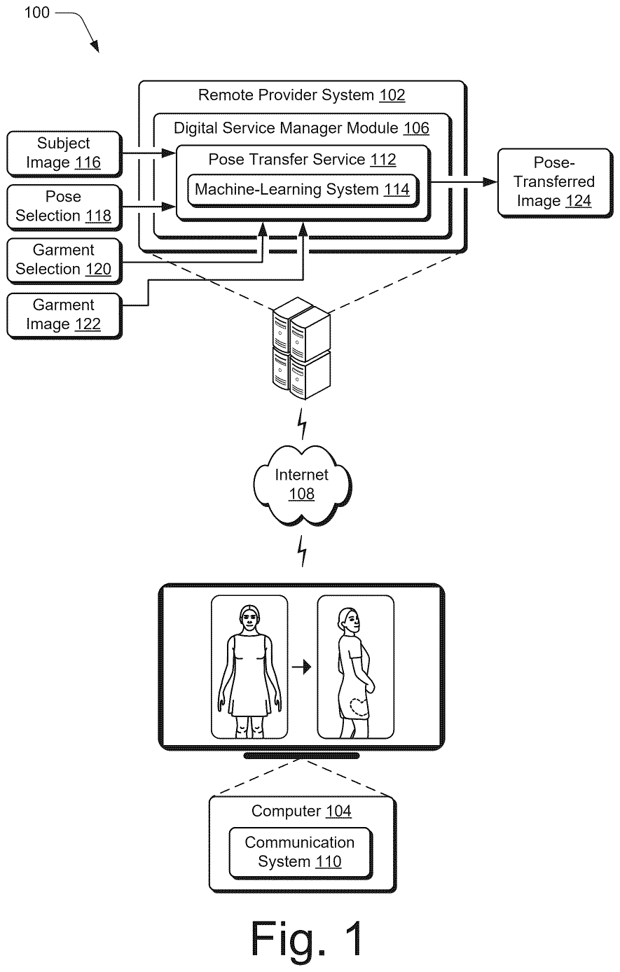

FIG. 1 illustrates a digital medium environment 100 in an example implementation that is operable to employ remote pose transfer techniques as described herein. The illustrated digital medium environment 100 includes a remote provider system 102 and a computer 104 that are communicatively coupled, one to another, via the Internet or another wired or wireless network. Computing systems for the remote provider system 102 and the computer 104 are configurable in various ways. For instance, the computer 104 is associated with a user, and the remote provider system 102 is a remote computing system (e.g., one or more servers) configured to employ the described techniques and systems for remote pose transfer.

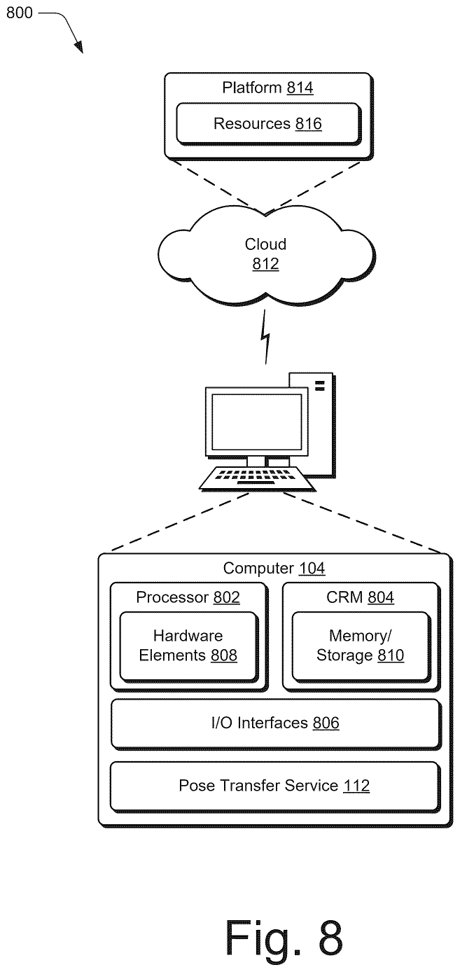

A computing system, for instance, is configurable as a desktop computer, laptop computer, mobile device (e.g., assuming a handheld configuration such as a tablet or mobile phone), server, and so forth. Thus, the remote provider system 102 or the computer 104 can range from a full-resource device with substantial memory and processor resources (e.g., servers and personal computers) to a low-resource device with limited memory and/or processing resources (e.g., some mobile devices). Additionally, although a single computing device is shown for the computer 104 and described in instances in the following discussion, a computing system is also representative of a plurality of different devices, such as multiple servers utilized by a business to perform operations “over the cloud” for the remote provider system 102 and as further described in relation to FIG. 8.

The remote provider system 102 includes a digital service manager module 106 implemented using hardware and software resources (e.g., a processing device and computer-readable storage medium) to support one or more digital services (e.g., an online marketplace). The digital services are made available remotely via the Internet 108 to computing devices (e.g., computer 104).

The digital services are scalable through implementation by the hardware and software resources and support a variety of functionalities, including accessibility, verification, real-time processing, analytics, load balancing, and so forth. Examples of digital services include a social media service, online marketplace, streaming service, digital content repository service, content collaboration service, and so on. Accordingly, in the illustrated example, a communication system 110 (e.g., browser, network-enabled application, and so on) is utilized by the computer 104 to access digital services via the Internet 108. The result of processing using the digital services is then returned to the computer 104 via the Internet 108.

In the illustrated digital medium environment 100, the digital services include a pose transfer service 112 for assisting online purchasers in generating images depicting themselves in various poses. The images can be used for virtual garment try-on. For example, the pose transfer service 112 uses a machine-learning system 114 to process a subject image 116, a pose selection 118, a garment selection 120, and a garment image 122 to generate a pose-transferred image 124. Given the subject image 116 capturing an image of the individual (or another individual) and the pose selection 118, the pose transfer service 112 generates the pose-transferred image 124 that includes a digital representation of the individual in the pose specified by the pose selection 118. Additionally, given the garment selection 120 and the garment image 122, the pose transfer service 112 generates the pose-transferred image 124 to depict the individual wearing the garment depicted by the garment image 122. The garment image 122 provides an example image or photograph of a person or mannequin wearing the garment selection 120. The pose transfer service 112 captures the fine-grain garment fit and style (e.g., looseness on the shoulder and tightness on the waist) of the garment selection 120 from the garment image 122 and transfers those details to the pose-transferred image 124.

The pose-transferred image 124 readily depicts the individual in the pose specified by the pose selection 118 upon the user's interaction with a user interface (UI) of the computer 104. Visually, the pose transfer service 112 swaps the pose of the individual in the subject image 116 with the pose specified by the pose selection 118 realistically and plausibly.

As an example, the subject image 116 can depict the individual in a pose in which the front portion of the individual (e.g., the front of the individual's face, chest, and so forth) faces the plane of view of the subject image 116. The pose selection 118 can be set to specify a different pose for the individual, such as a pose in which side portions of the individual (e.g., the side of the individual's face, arm, and so forth) face the plane of view. In this example, the pose transfer service 112 is operable to generate the pose-transferred image 124 depicting the individual in the pose in which the side portions of the individual face the plane of view. To do so, the pose transfer service 112 receives the subject image 116 as input. The pose transfer service 112 is operable to generate pose-transferred images depicting the individual in different poses even if those poses are not depicted by the subject image 116. Further, the pose transfer service 112 can do so using the single subject image 116 as input without additional images of the individual.

As described above, the pose transfer service 112 is also operable to generate the pose-transferred image 124 such that the individual is depicted in the pose specified by the pose selection 118 while wearing the garment depicted by the garment image 122. Compared to conventional approaches that generally display digital images of other human models wearing garments, the described techniques for remote pose transfer increase an amount of information available to individuals with regard to the fit and shape of garments.

The garment selection 120 can be input to the pose transfer service 112 by a user via a user input device such as a mouse, keyboard, trackpad, and the like. In some implementations, the garment image 122 may be determined by the pose transfer service 112 based on the garment selection 120 and the pose selection 118. For example, multiple garment images depicting the garment of the garment selection 120 worn by other individuals in various poses may be accessible by the pose transfer service 112. The multiple garment images may be referred to as a plurality of candidate images. The pose transfer service 112 may determine which of the multiple images to use for the garment image 122 based on similarity between the pose selection 118 and the poses of the individuals shown in the multiple images. For instance, the pose selection 118 may specify a side-view pose, and the pose transfer service 112 may determine the garment image 122 to be used in the generation of the pose-transferred image 124 based on which of the multiple images depict larger amounts of the sides of the garment.

The pose transfer service 112 is configurable to employ the machine-learning system(s) 114 to determine a user's dimensions (e.g., chest size, shoulder width, etc.) from a single uploaded image (e.g., the subject image 116). The user's dimensions are used to generate a mesh model of the user, which is then used by the same machine-learning system 114 or another machine-learning system along with the pose selection 118 and the garment image 122 to generate the pose-transferred image 124 of the individual wearing the garment depicted by the garment image 122 in the pose specified by the pose selection 118. In some implementations, the machine-learning system 114 can also use garment details (e.g., various measurements) to fit the garment depicted by the garment image 122 on the mesh model representation of the user. Further discussion of these and other examples is included in the following section and shown in the corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Remote Pose Transfer

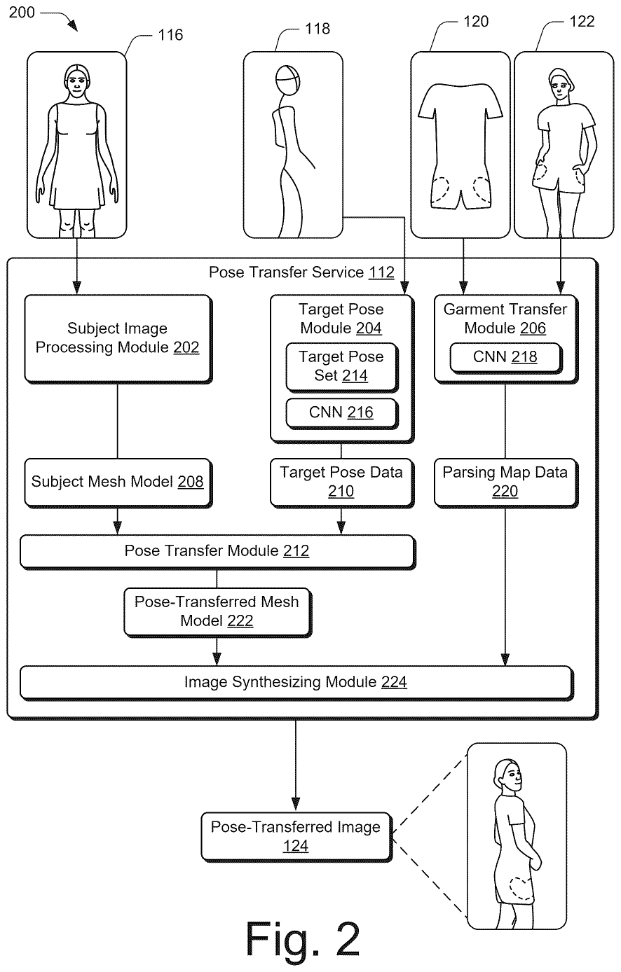

FIG. 2 depicts a system 200 in an example implementation showing the operation of the pose transfer service 112 of FIG. 1 as employing the techniques described herein. The pose transfer service 112 is configurable to implement a pipeline to address technical challenges, supporting the generation of pose-transferred images (e.g., pose-transferred image 124) that depict an individual shown by a subject image (e.g., subject image 116) in a pose specified by the pose selection 118 and, in some instances, wearing a garment depicted by the garment image 122. To do so, the pose transfer service 112 employs a subject image processing module 202, a target pose module 204, and a garment transfer module 206.

The subject image processing module 202 is configured to process the subject image 116 to generate a subject mesh model 208. In particular, the subject image processing module 202 uses at least one machine-learning model to extract the subject's measurements (e.g., chest width, torso length, etc.) from the subject image 116 and generate the subject mesh model 208. The subject mesh model 208 is proportioned to match the extracted or determined measurements of the subject. The generation of the subject mesh model 208 is described in greater detail in U.S. patent application Ser. No. 18/787,363, filed on Jul. 29, 2024, and is hereby incorporated in its entirety herein.

The subject mesh model 208 can be generated from a single image, e.g., the subject image 116. In the single image, portions of the body of the individual depicted by the subject image 116 may not be visible. However, the at least one machine-learning model is trained to determine measurements corresponding to portions of the body of the individual that are not visible in the subject image 116 (e.g., depths of portions of the body in directions toward or away from the plane of view of the subject image 116). To do so, the at least one machine-learning model is operable to determine measurements for the non-visible portions of the body based on the measurements of the visible portions of the body.

In an example, the at least one machine-learning model is operable to determine a width of arms of the individual, a width of the torso of the individual, and the width between the shoulders of the individual. Based on the widths, the at least one machine-learning model is operable to determine depths for the arms, torso, and/or shoulders, and the determined depths can be utilized for depicting the individual in various different poses in accordance with the described techniques. In order to determine the depths, the at least one machine-learning model is trained on pairs of images depicting individuals in different poses and measurements associated with those individuals. The at least one machine-learning model may include, for example, a parametric model operable to generate a mesh representing the individual using the measurements. In some implementations, the at least one machine-learning model further includes a convolutional neural network (CNN) operable to determine the measurements from the subject image 116.

The target pose module 204 is configured to process the pose selection 118 to provide target pose data 210 associated with the pose selection 118 to a pose transfer module 212. To do so in some implementations, the target pose module 204 is operable to identify the target pose data 210 associated with the pose selection 118 from a target pose set 214. The target pose set 214 is accessible by the target pose module 204 and includes data describing a plurality of target poses. Based on the pose selection 118, the target pose module 204 provides the target pose data 210 associated with the pose selection 118 from the target pose set 214 to the pose transfer module 212.

The pose selection 118 may be input in a variety of ways. In some implementations, the pose selection 118 may be input by way of user selection of an image and/or description of the pose (e.g., using an input device such as a mouse, keyboard, etc. to select the image and/or description in a graphical user interface). Each pose in the target pose set 214 may be associated with a different respective image and/or description selectable via user input as described above. In some implementations, the pose selection 118 may be input using natural language. For instance, a natural language description of a pose may be input by a user to the pose transfer service 112 using a user input device such as a keyboard, microphone, etc. The pose transfer service 112 may employ one or more machine-learning models (e.g., a large language model) to process the natural language description of the pose and determine the pose selection 118 based on the processed natural language description (e.g., by comparing keywords in the natural language description with keywords in metadata associated the poses in the pose set 214).

In some instances, the poses in the pose set 214 may be predefined such that the pose set 214 includes a fixed number of poses. In some instances, the pose transfer service 112 is operable to add poses to the pose set 214 based on the natural language input. For example, the pose transfer service 112 may employ one or more machine-learning models to generate additional poses for inclusion in the pose set 214. Generation of additional poses may include, for example, compositing portions of different poses (e.g., a torso from a first pose in a first orientation and a head from another pose in another orientation).

In some implementations, the poses of the pose set 214 may be depicted via a graphical user interface displayed by the pose transfer service 112 at a display device (e.g., a display screen of the computer 104). Each pose of the pose set 214 may be represented by a respective image in the graphical user interface. In some instances, the images depict a mannequin or human model in the poses. In some instances, the poses of the pose set 214 may be represented by a three-dimensional model in the graphical user interface. The three-dimensional model may be rotatable by way of user input applied to the graphical user interface (e.g., input from a user input device such as a mouse, trackpad, etc.). In an example operation, a user may rotate the three-dimensional model until the model depicts the desired pose. The user may confirm the pose of the rotated three-dimensional model as the pose selection 118 via an element of the graphical user interface (e.g., a confirmation button).

In some implementations, the target pose data 210 includes data describing measurements (e.g., chest width, torso length, etc.) of a mannequin or virtual representation of a human body. The measurements may be the same for each instance of the target pose data 210. However, the target pose data 210 additionally includes data describing a position, angle, orientation, etc. of portions of the mannequin or virtual representation of the human body in the pose associated with the pose selection 118. The data describing the position, angle, orientation, etc. may be different for each pose. In some implementations, the target pose data 210 includes a target pose mesh model in the pose associated with the pose selection 118. The target pose mesh model may be referred to herein as a reference mesh model and/or reference human model.

In some implementations, the target pose module 204 is operable to generate recommendations for pose selections based on the subject image 116. For example, the target pose module 204 may receive input from the subject image processing module 202, such as the subject mesh model 208, and employ one or more machine-learning models such as a CNN 216 to determine similarity between the pose of the individual depicted by the subject image 116 and one of the poses of the target pose set 214. Based on which poses of the target pose set 214 are similar to the pose of the individual depicted by the subject image 116, the target pose module 204 may generate recommendations for selections of poses that are dissimilar to the pose associated with the subject image 116. For example, in a situation in which the individual in the subject image 116 is posed such that the individual's face and torso are facing the plane of view in the subject image 116, the target pose module 204 may generate a recommendation for the pose selection 118 using target poses that include the head and torso of the models facing away from the plane of view (e.g., a side profile pose).

In some implementations, the CNN 216 is operable to determine similarity between the pose specified by the pose selection 118 and poses depicted in multiple images from which the garment image 122 is selected. For example, as described above, multiple images depicting the garment of the garment selection 120 worn by other individuals may be accessible to the pose transfer service 112. The pose transfer service 112 may select the garment image 122 to be used for the processes relating to generation of the pose-transferred image 124 based on which image of the multiple images depicts a pose similar to the pose of the pose selection 118. To determine the similarity, the multiple images may be accessible to the CNN 216, with the CNN 216 operable to determine which image of the multiple images depicts a pose similar to the pose of the pose selection 118.

The garment transfer module 206 is configured to analyze, using a CNN 218, the garment selection 120 and the garment image 122 to generate and look up parsing map data 220. Measurements and dimensions of garments selectable by users are generally known by the pose transfer service 112 or readily available for lookup by the garment transfer module 206. In one implementation, the garment transfer module 206 looks up at least some of the parsing map data 220 (e.g., a minimum set of measurements) for the garment of the garment selection 120 and extrapolates or determines other parsing map data 220 based on the provided data. The parsing map data 220 includes different measurements (e.g., sleeve length, wrist diameter, neck opening diameter, torso length, inseam, waist circumference) and characteristics (e.g., stretchiness, material, drape, color) of the garment of the garment selection 120.

Outputs of the subject image processing module 202 (e.g., the subject mesh model 208) and the target pose module 204 (e.g., the target pose data 210) are received as inputs by the pose transfer module 212 to generate a pose-transferred mesh model 222. An image synthesizing module 224 is operable to receive the output of the pose transfer module 212 (e.g., the pose-transferred mesh model 222) as input to generate the pose-transferred image 124. In some instances, the image synthesizing module 224 can output the pose-transferred image 124 to depict the individual in the subject image 116 in the pose associated with the pose selection 118 while maintaining the depicted garments worn by the individual in the pose-transferred image 124 as consistent with the garments depicted in the subject image 116. For example, during situations in which the garment selection 120 is not input, the image synthesizing module 224 can generate the pose-transferred image 124 without swapping the garments worn by the individual in the subject image 116 for different garments. However, the image synthesizing module 224 is also operable to receive the output of the pose transfer module 212 and the output of the garment transfer module 206 (e.g., the parsing map data 220) to generate the pose-transferred image 124 depicting the individual wearing the garments specified by the garment selection 120. Compared with conventional techniques, the pose transfer service 112 exhibits improved remote fitting of garments by way of remote pose transfer to improve online shopping experiences and reduce the hassle associated with poor fitting purchases.

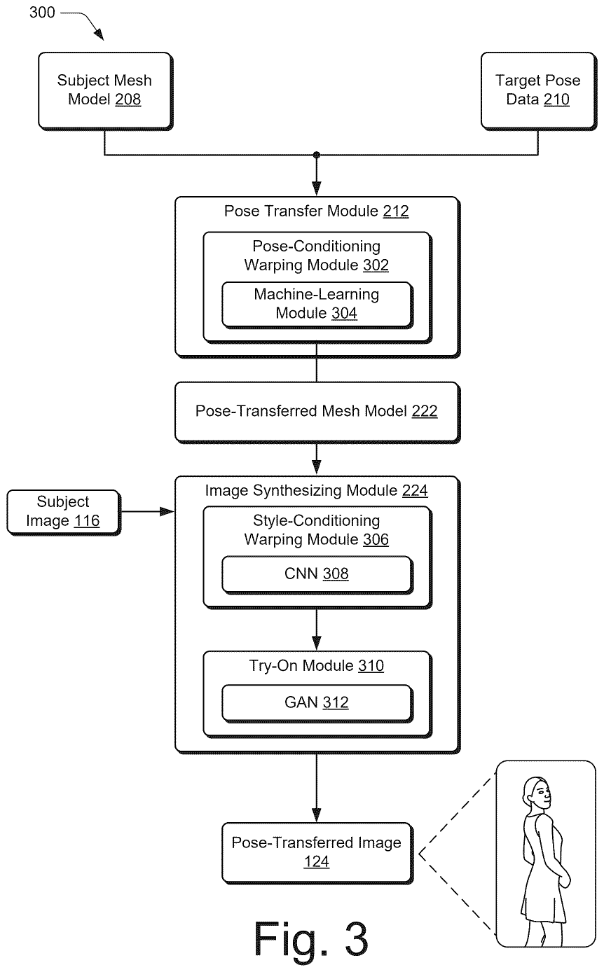

FIG. 3 depicts a system 300 in an example implementation showing the operation of modules of the pose transfer service 112 of FIG. 1 in greater detail. The pose transfer module 212 includes a pose-conditioning warping module 302, which includes a machine-learning module 304 employing one or more machine-learning models.

The pose transfer module 212 receives as inputs the subject mesh model 208 and the target pose data 210. The pose-conditioning warping module 302 employs the one or more machine-learning models included by the machine-learning module 304 to generate the pose-transferred mesh model 222. In some implementations, the machine-learning module 304 includes a CNN operable to generate mappings between the subject mesh model 208 and the target pose data 210. The mappings may describe connections (e.g., similarities) between portions of the subject mesh model 208 and the measurements, angles, positions, orientations, and so forth described by the target pose data 210.

In some implementations, the machine-learning module 304 includes a skinned multi-person linear (SMPL) model operable to generate the pose-transferred mesh model 222 using the subject mesh model 208, the target pose data 210, and the mappings. An SMPL model is a parametric three-dimensional (3D) body model that utilizes machine learning. SPML models use a blend of linear skinning and blend shapes to represent a wide range of human body shapes and poses. Linear skinning uses weights to deform a base mesh according to a skeleton, allowing for basic body movements. Blend shapes are pre-defined shapes added to the base mesh to capture details like muscle bulges. The parameters that control the weights and blend shapes in SMPL models are learned from a large dataset of 3D body scans, allowing them to represent a statistically realistic range of human body shapes. Here, the SMPL model is further trained on mappings between mesh models and target pose data to be able to generate pose-transferred mesh models (e.g., the pose-transferred mesh model 222) from subject mesh models generated from subject images (e.g., the subject mesh model 208). The SMPL model learns the statistical relationships between the pose, shape, and appearance of the body features represented by the mesh models and the target pose data using the mappings. The learned parameters are then used to define the weights and blend shapes within the SMPL model for generating pose-transferred mesh models.

The subject mesh model 208 and the pose-transferred mesh model 222 are each 3D representations of the human body (e.g., the body of the subject in the subject image 116) made up of polygons (e.g., triangles). The polygons connect to form a surface that defines the shape and volume of the body. The subject mesh model 208 and the pose-transferred mesh model 222 thus each provide a realistic body shape for the subject (e.g., consumer), with the pose-transferred mesh model 222 having the pose specified by the pose selection 118.

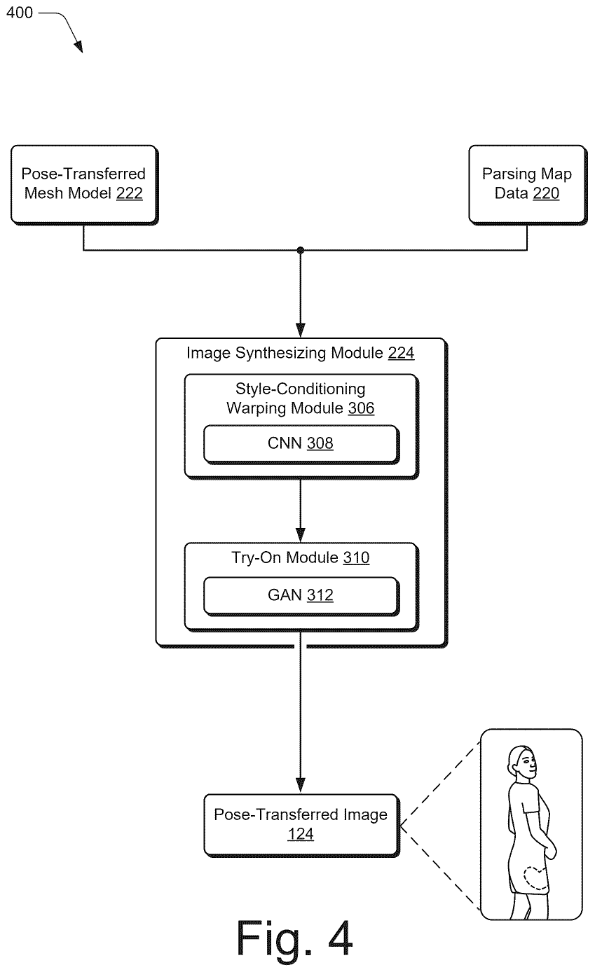

The image synthesizing module 224 includes a style-conditioning warping module 306, which includes a CNN 308, and a try-on module 310, which includes a generative adversarial network (GAN) 312. The image synthesizing module 224 receives as input the pose-transferred mesh model 222. In situations in which the garment selection 120 is not input, the image synthesizing module 224 may further receive the subject image 116 as input in order to generate the pose-transferred image 124 depicting the subject in the pose of the pose selection 118 and wearing the garments worn by the subject in the subject image 116. To do so in some implementations, the image synthesizing module 224 may utilize measurements and dimensions associated with a similar garment known by the pose transfer service 112 or readily available for lookup by the garment transfer module 206 as measurements and dimensions, respectively, of the garment worn by the subject in the subject image 116. The image synthesizing module 224 may thus warp the garments worn by the subject of the subject image 116 to fit the pose-transferred mesh model 222 in a manner similar to that described below with reference to FIG. 4. In situations in which the garment selection 120 is input, the image synthesizing module 224 is operable to generate the pose-transferred image 124 showing the garment associated with the garment selection 120 worn by the subject as described below with reference to FIG. 4.

FIG. 4 depicts a system 400 in an example implementation showing the operation of the image synthesizing module 224 of the pose transfer service 112 of FIG. 2 in greater detail. As described above, the image synthesizing module 224 includes the style-conditioning warping module 306, which includes the CNN 308, and the try-on module 310, which includes the GAN 312.

The image synthesizing module 224 receives as inputs the pose-transferred mesh model 222 and the parsing map data 220. The style-conditioning warping module 306 renders the garment of the garment selection 120 on the pose-transferred mesh model 222 based on the parsing map data 220 output by the garment transfer module 206. In particular, the CNN 308 uses the parsing map data 220 to warp and fit the garment of the garment selection 120 to the pose-transferred mesh model 222 consistent with the fit and style reflected in the garment image 122. The CNN 308 is trained using the parsing map data 220 from unpaired data sets. In one implementation, the CNN 308 of the style-conditioning warping module 306 is trained independently from the CNN 218 of the garment transfer module 206. The independent training of the CNN 308 ensures the style-conditioning warping module 306 accurately deforms or warps the flat garment from the garment selection 120 onto the pose-transferred mesh model 222.

The try-on module 310 generates the final remote fitting result of the warped garment on the subject person. The try-on module 310 uses the GAN 312 to synthesize the style-conditioning warped garment output by the style-conditioning warping module 306 on the pose-transferred mesh model 222 to obtain photo-realistic results in the pose-transferred image 124. The GAN 312 uses a spatially adaptive normalization (SPADE) technique to improve the image generation quality of the image-to-image translation of features of the subject in the subject image 116 and the garment image 122 to the pose-transferred image 124.

The GAN 312 receives as inputs the semantic segmentation map of the warped garment and uses it to adaptively normalize the activations of the convolutional layers in the generator network. The adaptive normalization allows the GAN 312 to better capture the spatial details and structure of the warped garment as it overlaps and fits on the pose-transferred mesh model 222. The normalized parameters (e.g., gamma and beta) are modulated by the semantic segmentation map, enabling the GAN 312 to control the style and appearance of the pose-transferred image 124 based on the semantic information. The try-on module 310 also uses a loss function on the skin map to enhance the skin synthesis for the pose-transferred image 124. The GAN 312 is also robust to occlusion (e.g., caused by hair, arms, etc.) in the subject image 116 or the garment image 122 and can fill in the missing information during the synthesis process. Remote fitting is described in greater detail in U.S. patent application Ser. No. 19/003,483, filed on Dec. 27, 2024, and is hereby incorporated in its entirety herein.

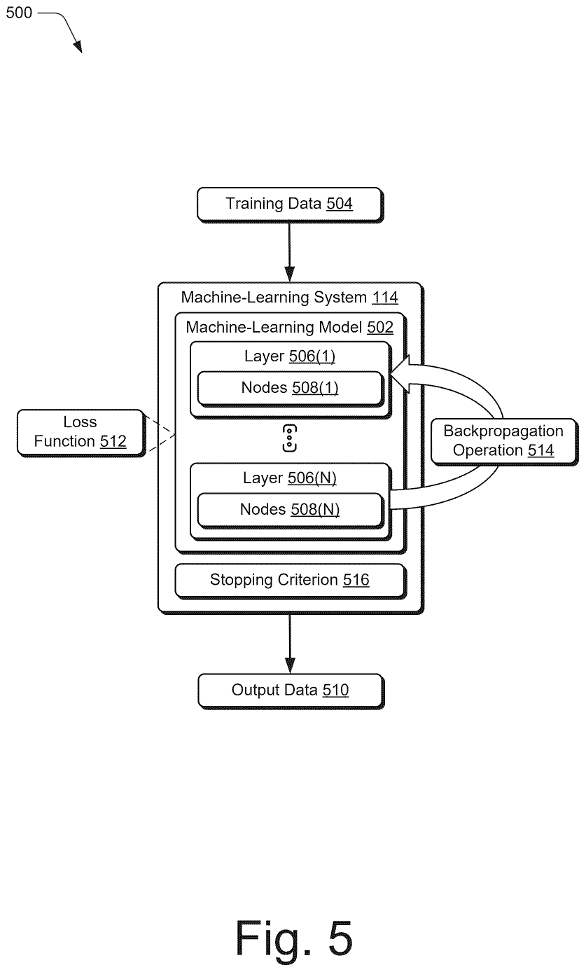

FIG. 5 depicts a system and procedure in an example implementation 500 for training a machine-learning model 502 as part of the machine-learning system 114 of FIG. 1. The machine-learning model 502 is illustrated as implemented as part of the machine-learning system 114. The machine-learning system 114 is representative of functionality to generate training data 504, use the generated training data 504 to train the machine-learning model 502, and/or use the trained machine-learning model 502 as implementing the functionality described herein.

A “machine-learning model” refers to a tunable computer representation (e.g., through training and retraining) based on inputs without being actively programmed by a user to approximate unknown functions, automatically and without user intervention. In particular, the term machine-learning model includes a model that utilizes algorithms to learn from and make predictions on known data by analyzing training data to learn and relearn to generate outputs that reflect patterns and attributes of the training data. Examples of machine-learning models include neural networks, CNNs, long short-term memory (LSTM) neural networks, GANs, decision trees, support vector machines, linear regression, logistic regression, Bayesian networks, random forest learning, dimensionality reduction algorithms, boosting algorithms, deep learning neural networks, etc.

In this context, the machine-learning model 502 employs a diffusion model. A “diffusion model” is a generative machine-learning model for digital content creation (e.g., pose-transferred image 124). To train the diffusion model, noise is added to training data samples until the data within the training data samples is obscured. The diffusion model is then trained self-supervised to reverse this process based on training data with a text prompt describing the digital content to be created to generate data samples as the digital content corresponding to the text prompt. To train the diffusion model, the underlying machine-learning model 502 is provided with the training data 504 that includes examples of images to train and retrain the model to predict the image to be generated.

In some implementations, the machine-learning model 502 also employs a parametric model. A parametric model uses a fixed number of parameters to represent the data (e.g., mesh models) it describes. In other words, these parameters act as the knobs turned to adjust the model's fit to the data. Parametric models use a finite or predetermined set of parameters. Because they have a fixed number of parameters, parametric models are often simpler to train and require less data than non-parametric models.

In the illustrated example, the machine-learning model 502 is configured using a plurality of layers 506(1), ..., 506(N) having, respectively, a plurality of nodes 508(1), ..., 508(N). The plurality of layers 506(1)-506(N) are configurable to include an input layer, an output layer, and one or more hidden layers. Calculations are performed by the nodes 508(1)-508(N) within the layers via hidden states through a system of weighted connections that are “learned” during training to implement a variety of tasks (e.g., caption generation).

To train the machine-learning model 502, the training data 504 is received that provides examples of “what is to be learned” by the machine-learning model 502, i.e., as a basis to learn patterns from the data. The machine-learning model 502, for instance, collects and preprocesses the training data 504 that includes input features and corresponding target labels, i.e., of what is exhibited by the input features. The machine-learning system 114 then initializes the parameters of the machine-learning model 502, which the machine-learning system 114 uses as internal variables to represent and process information during training and represent interferences gained through training. In an implementation, the training data 504 is separated into batches to improve the processing and optimization efficiency of the parameters during training.

The training data 504 is then received as input and used to generate predictions based on the current state of parameters of layers 506(1)-506(N) and corresponding nodes 508(1)-508(N) of the model. The machine-learning model 502 outputs its result as output data 510. The output data 510 describes an outcome of the task (e.g., generating a pose-transferred image).

Training the machine-learning model 502 includes calculating a loss function 512 to quantify a loss associated with operations performed by nodes 508(1)-508(N) of the machine-learning model 502. For instance, calculating the loss function 512 includes comparing a difference between predictions specified in the output data 510 with target labels specified by the training data 504. The loss function 512 is configurable in various ways, including regression, the quadratic loss function as part of a least squares technique, and so forth.

Calculating the loss function 512 also includes using a backpropagation operation 514 to minimize the loss function 512, thereby training the parameters of the machine-learning model 502. Minimizing the loss function 512 includes adjusting the weights of the nodes 508(1)-508(N) to minimize the loss and thereby optimize the performance of the machine-learning model 502 for a particular task. The adjustment is determined by computing a gradient of the loss function 512, which indicates a direction to be used to adjust the parameters for minimizing the loss. The parameters of the machine-learning model 502 are then updated based on the computed gradient.

This process continues over several iterations until a stopping criterion 516 is met. The stopping criterion 516 is employed by the machine-learning system 114 in this example to reduce overfitting of the machine-learning model 502, reduce computational resource consumption, and promote an ability to address previously unseen data, i.e., that is not included specifically as an example in the training data 504. Examples of the stopping criterion 516 include but are not limited to a predefined number of epochs, validation loss stabilization, achievement of a performance improvement threshold, or based on performance metrics such as precision and recall.

### Example Remote Pose Transfer Procedures

The following discussion describes remote pose transfer techniques that are implementable utilizing the described systems and devices. Aspects of each procedure are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions, thereby creating a special-purpose machine for carrying out an algorithm as illustrated by the flow diagram. As a result, the instructions are stored on a computer-readable storage medium that causes the hardware to perform the algorithm, e.g., responsive to the execution of the instructions. In portions of the following discussion, reference will be made to FIGS. 1-5.

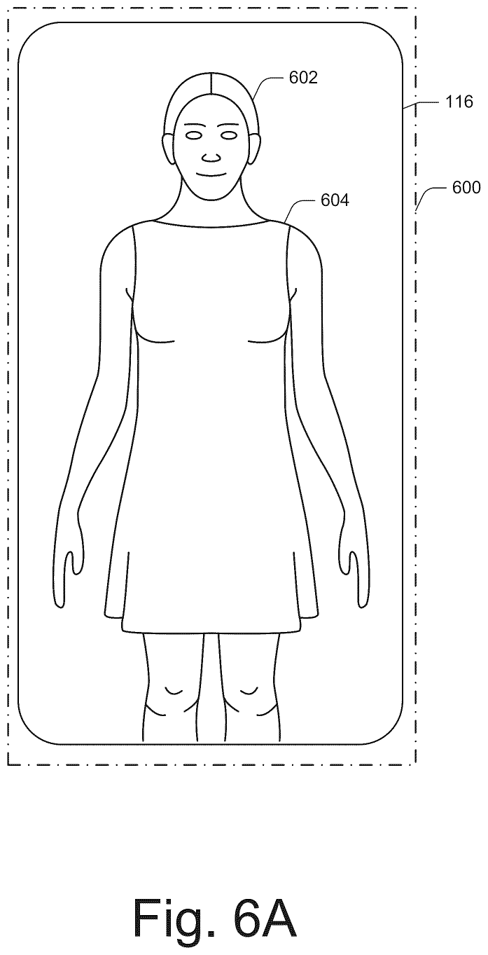

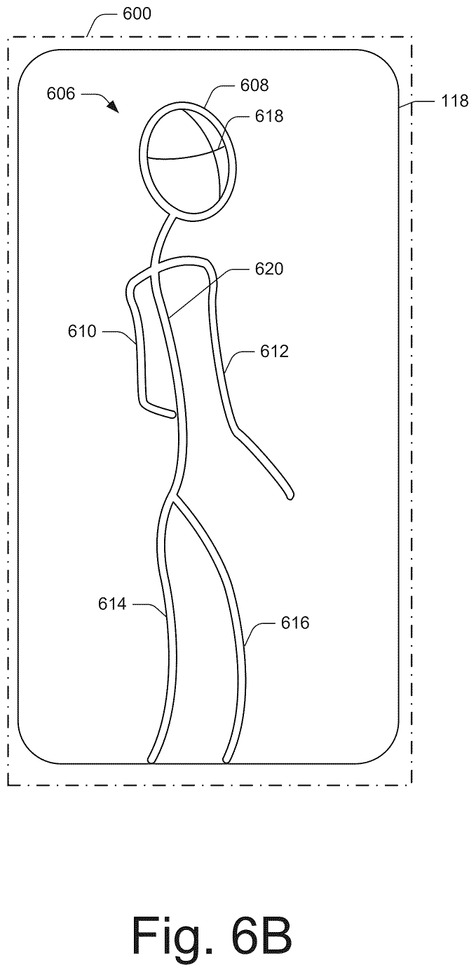

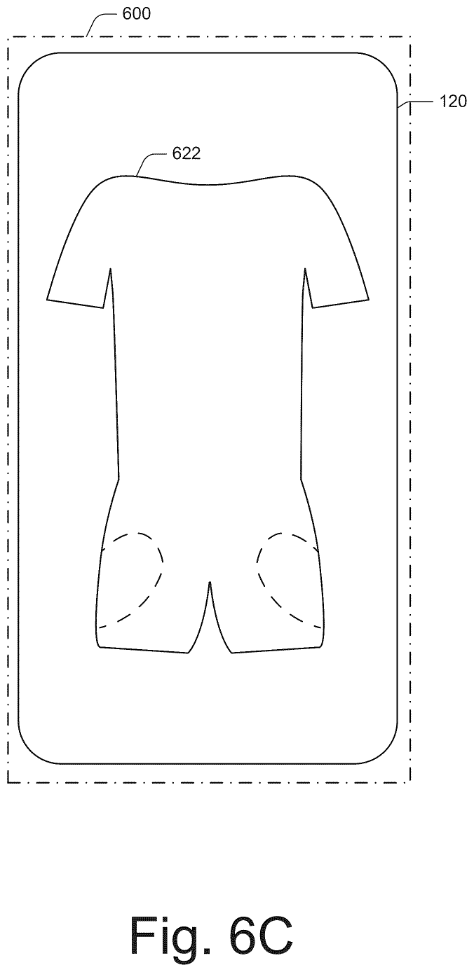

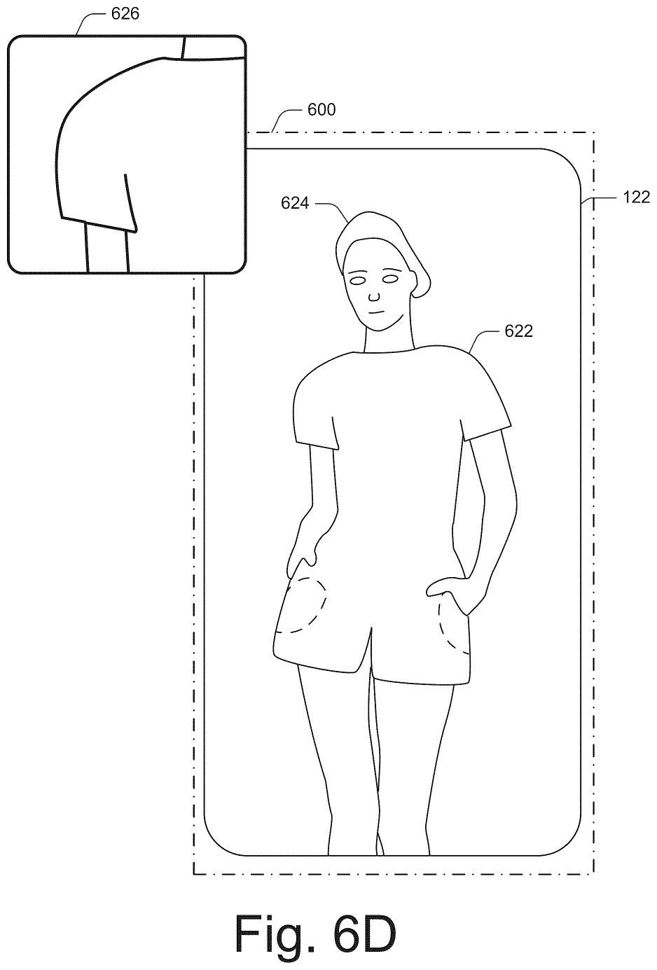

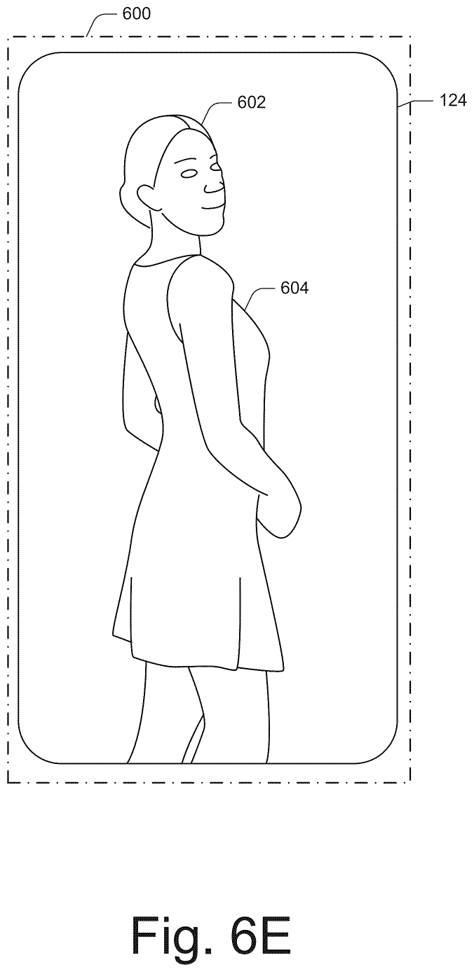

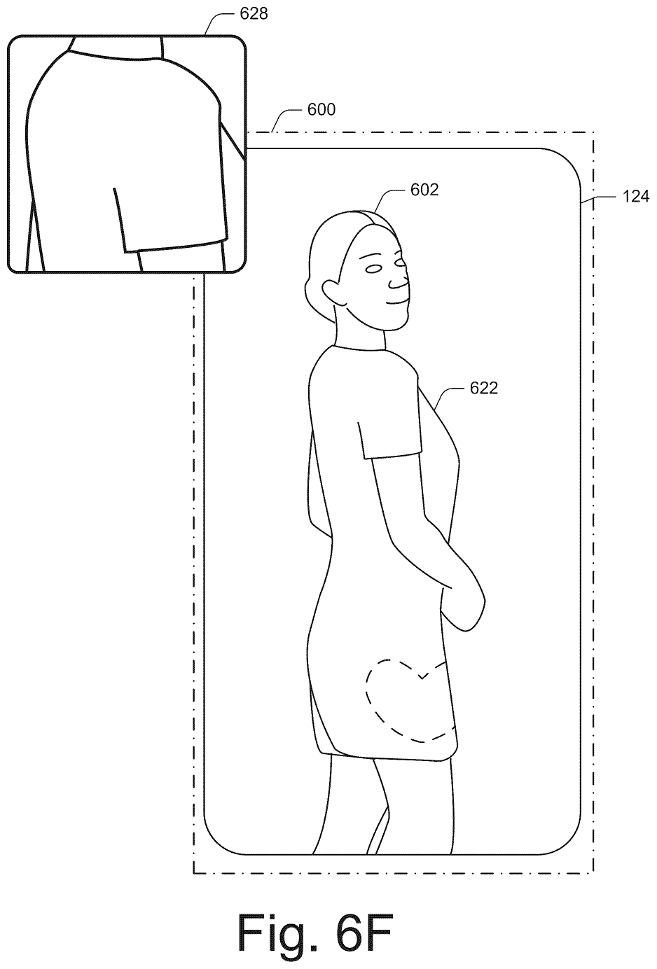

FIGS. 6A through 6F depict an example user interface 600 to employ the remote pose transfer techniques described herein. The user interface 600 includes the subject image 116, the pose selection 118, the garment selection 120, the garment image 122, a first configuration of the pose-transferred image 124, and a second configuration of the pose-transferred image 124 in FIGS. 6A, 6B, 6C, 6D, 6E, and 6F, respectively. In other implementations, the user interface 600 includes additional or fewer components, including an option to change the apparel selection's size, color, or pattern.

In FIG. 6A, the subject image 116 represents a subject 602 (e.g., online purchaser) wearing a garment 604 owned by the subject (e.g., physically present with the subject). The subject uploads or selects the subject image 116 from memory associated with the user's electronic device or the clothing application. In one implementation, the subject image 116 includes a front view of the subject, but different-facing views are provided in different implementations.

In FIG. 6B, the pose selection 118 is depicted via an image of a mannequin 606 representing a human body in a particular pose. Portions of the mannequin 606 are representative of corresponding portions of the human body. For example, the mannequin 606 includes a head 608, a first arm 610, a second arm 612, a first leg 614, a second leg 616, and so forth. The mannequin 606 further includes curved lines 618 at the head 608 that indicate the direction that the head 608 faces. For instance, the intersection of the curved lines 618 may represent a position of the nose of the human body. The pose of the mannequin 606 is described by the target pose data 210 associated with the pose selection 118. In the example shown, the mannequin 606 is posed such that a torso 620 of the mannequin 606 angles away from the plane of view. In this pose, the first arm 610 and the first leg 614 are further from the plane of view, and the second arm 612 and the second leg 616 are closer to the plane of view. Additionally, in this pose, the head 608 is angled toward the plane of view such that the head 608 partially faces the plane of view as indicated by the curved lines 618.

In FIG. 6C, the garment selection 120 is depicted. The garment selection 120 shows a garment 622 to be depicted as worn by the individual in the pose-transferred image 124. In this example, the garment 622 is a jumpsuit. However, the example shown is non-limiting and other types of garments can be selected. For example, the garment selection 120 may specify garments such as shirts, pants, shorts, dresses, hats, wristwear, footwear, outerwear, and so forth. In some implementations, the garment selection 120 may include accessories such as jewelry, hair ties, eyewear, and so forth.

In FIG. 6D, the garment image 122 represents a model 624 or example person wearing the garment selection 120. The model 624 representation can include a mannequin wearing the garment 622 of the garment selection 120 in one implementation. The garment image 122 provides an example of the designer's intended fit and style of the garment 622 of the garment selection 120. A blow-out 626 provides a zoomed-in look at the fit and style of the dress as it wraps over the model's shoulder. The blow-out 626 is an example segmentation that the CNN 308 of the style-conditioning warping module 306 collects to ensure proper fit and style transfer to the subject person.

In FIG. 6E, the pose-transferred image 124 is shown depicting the subject 602 wearing the garment 604 shown in the subject image 116. In this example, the pose selection 118 and the subject image 116 are received by the pose transfer service 112 without the garment selection 120 input to the pose transfer service 112. As a result, the pose-transferred image 124 is generated by the image synthesizing module 224 to depict the subject 602 in the pose specified by the pose selection 118 without swapping the garments worn by the subject 602.

In some implementations, the pose-transferred image 124 can be stored (e.g., stored to a memory of the remote provider system 102, stored to a user device, stored to cloud storage, etc.). The pose-transferred image 124 may then be used as input to the pose transfer service 112 to generate additional images. For example, the pose-transferred image 124 may be provided to the pose transfer service as the subject image 116 for generating one or more additional pose-transferred images depicting the subject 602 in different poses and/or different garments. As one example, the pose-transferred image 124 may be provided as input to the pose transfer service 112 (e.g., used as the subject image 116) along with the garment selection 120 and the pose selection 118. However, the pose selection 118 may specify the pose already depicted by the pose-transferred image 124 that is provided as input. As a result, the image output by the pose transfer service 112 may maintain the pose while swapping the depicted garment with the garment selection 120.

In some implementations, an individual can utilize the pose transfer service 112 to generate multiple pose-transferred images to form a set of pose-transferred images that depict the individual in different poses. Images from the set can then be used for virtual try-on of garments as described above (e.g., by providing the images as input to the pose transfer service 112 along with the garment selection 120 and the corresponding pose selection 118).

In FIG. 6F, the pose-transferred image 124 represents the subject (e.g., the individual browsing garments online) wearing the garment selection 120 in the pose specified by the pose selection 118. The subject representation can include a mannequin image with body proportions based on the subject mesh model 208 and the orientation, position, angle, etc. of the mannequin based on the pose selection 118. In other implementations, the subject representation reproduces the user based on the subject image 116, with the body of the user in the pose specified by the pose selection 118. In FIG. 6F, the pose-transferred image 124 includes a side-facing view of the subject person, but different-facing views can be generated by selecting the desired pose via the pose selection 118. In some implementations, multiple pose-transferred images may be combined (e.g., stitched together, composited, etc.) to form a three-dimensional view of the subject that can be rotated or seen from different perspectives. A blow-out 628 provides a zoomed-in look at the fit and style of the dress as it wraps over the subject person's shoulder.

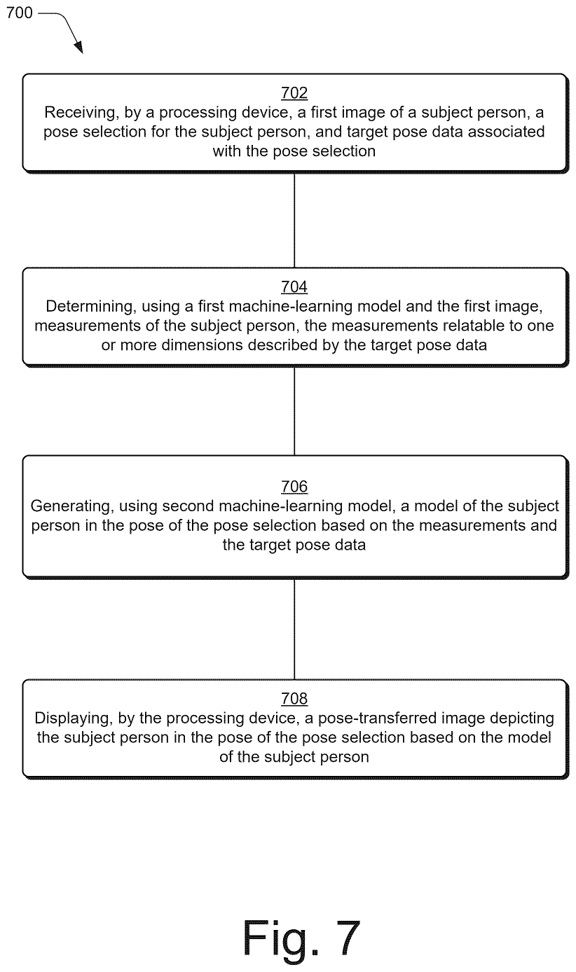

FIG. 7 is a flow diagram depicting an algorithm as a step-by-step procedure 700 in an example implementation of operations performable for accomplishing a result of remote pose transfer. To begin, a first image of a subject person and a pose selection is received (block 702). For example, the pose transfer service 112 receives the subject image 116 of the user (or another person) and the pose selection 118 selected according to a pose to be transferred to the subject. The pose transfer service 112 may also receive the garment selection 120 and the garment image 122 in situations in which the garment of the garment selection 120 is to be depicted as worn by the subject of the subject image 116 as described above.

A first machine-learning model is used to determine measurements of the subject person based on the first image (block 704). The measurements relate or correspond to dimensions described by the target pose data 210. For example, the first machine-learning model is a parametric model (e.g., SPML model) that generates a representation of the subject person using a human mesh model with the measurements of the subject person. The measurements of the subject person may be of a same type (e.g., corresponding to the same type of body parts) and/or quantity as measurements described by the target pose data. Generating the representation includes, for example, generating the subject mesh model 208.

A second machine-learning model is used to generate a model of the subject person in the pose of the pose selection based on the measurements and the target pose data (block 706). In some implementations, the second machine-learning model is another parametric model or other type of machine-learning model (e.g., a CNN, GAN, etc.) employed to transform the orientation, position, and/or other characteristics of the subject mesh model based on the target pose data 210.

For example, the target pose data 210 is configurable to include data describing the positions and orientations of body parts corresponding to the pose associated with the pose selection 118. The second machine-learning model is operable to process the target pose data 210 and transform the subject mesh model 208 based on the target pose data 210 to generate the pose-transferred mesh model 222. The pose-transferred mesh model 222 maintains the size and real relative proportion of the body parts of the subject represented by the subject mesh model 208 while adjusting the position and orientation of the body parts based on the target pose data 210. In doing so, the second machine-learning model may utilize various constraints, ranges, and the like to ensure that the pose-transferred mesh model 222 accurately represents the body of the subject in the pose of the pose selection 118 while eliminating topological holes, intersections, and/or other aberrations that are not present in the real body of the subject.

As one example, the target pose data 210 may describe a position and orientation of appendages that would result in unrealistic intersection of corresponding appendages of the subject mesh model 208 for instances in which the corresponding appendages of the subject mesh model 208 are larger than those described by the target pose data 210. However, by employing the second machine-learning model to transform the subject mesh model 208 to generate the pose-transferred mesh model 222, occurrence of such abnormalities can be eliminated. In some implementations as described above, the target pose data 210 includes a target pose mesh model associated with the pose selection 118. The second machine-learning model may be operable to transform the subject mesh model 208 to generate the pose-transferred mesh model 222 using the target pose mesh model.

A pose-transferred image depicting the subject person in the pose of the pose selection based on the model of the subject person is displayed (block 708). For example, the pose-transferred image 124 is generated using the image synthesizing module 224, with the image synthesizing module 224 receiving the pose-transferred mesh model 222. As described above, the image synthesizing module 224 includes one or more machine-learning models employed to generate portrayals of the subject person using the pose-transferred mesh model 222 as input. In one implementation, the image of the subject person is projected onto the pose-transferred mesh model 222 to generate the portrayal of the subject person, and one or more garments included in the subject image 116 are warped and projected or synthesized onto the portrayal of the subject person in generating the pose-transferred image 124. As described above, the image synthesizing module 224 is configurable to include the style-conditioning warping module 306 having the CNN 308 and the try-on module 310 having the GAN 312 to support the generation of the pose-transferred image 124.

In some implementations as described above, the image synthesizing module 224 is operable to swap the garment worn by the subject person. For example, the subject person in the subject image 116 may be depicted wearing a first garment, and the garment selection 120 can be input to specify a different garment to be shown worn by the subject person in the pose-transferred image 124. A third machine-learning model can use the dimensions of the garment of the garment selection 120 (e.g., shoulder width, waist circumference, inseam length, hip circumference, sleeve length, sleeve circumference, collar opening diameter, chest width, chest diameter), which are determined or looked up by the processing device. In some implementations, the third machine-learning model includes a CNN (e.g., CNN 218) that transfers the fit of the garment in the garment image 122 to a portrayal of the subject person wearing the clothing item. The third machine-learning model is trained using pairs of images of different persons wearing different garments to learn to transfer the fit of the garments between people.

To determine the fit of the clothing item, the third machine-learning model extracts a relative correlation between a shape of the garment of the garment selection 120 and a body shape of the other person in the garment image 122 as a style code. The third machine-learning model then transfers the style code to obtain a parsing map that reflects how the clothing item fits on a human body. The parsing map provides geometric constraints to retain the fit of the clothing item from the garment image 122.

A determination of the fit of the clothing item further includes using a fourth machine-learning model to generate a warped clothing item from a flat representation of the clothing item to indicate how the clothing item fits on different parts of a human body. The warping is performed using the parsing map as a guide. In one implementation, the fourth machine-learning model includes a CNN (e.g., CNN 308) and a transformer that is trained independently from the third machine-learning model using parsing maps from unpaired data.

The processing device includes a GAN (e.g., GAN 312) or a generative diffusion model that generates the pose-transferred image 124 of the subject person wearing the garment of the garment selection 120 in the pose specified by the pose selection 118. In one implementation, the image of the subject person is projected onto the pose-transferred mesh model 222 to generate the portrayal of the subject person, and the warped garment is projected or synthesized onto the reproduced image of the subject person.

### Example System and Device

FIG. 8 illustrates an example system 800, which includes the example computer 104 that represents one or more computing systems and/or devices usable to implement the techniques described herein. This is illustrated through the inclusion of the pose transfer service 112. The computer 104 is configurable, for example, as a service provider server, a device associated with a client (e.g., a client device), an on-chip system, and/or any other suitable computing device or computing system.

The example computer 104, as illustrated, includes a processor 802, one or more computer-readable media 804, and one or more I/O interfaces 806 that are communicatively coupled, one to another. Although not shown, the computer 104 includes a system bus or other data and command transfer system that couples the various components. For example, a system bus includes any combination of different bus structures, such as a memory bus or controller, a peripheral bus, a universal serial bus, and/or a processor or local bus that utilizes various bus architectures. Various other examples are also contemplated, such as control and data lines.

The processor 802 represents the functionality to perform one or more operations using hardware. Accordingly, processor 802 is illustrated as including hardware elements 808 that are configured as processors, functional blocks, and so forth. This includes example implementations in hardware as an application specific integrated circuit or other logic device formed using one or more semiconductors. The hardware elements 808 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 804 is illustrated as including memory/storage 810. Memory/storage 810 represents memory or storage capacity associated with one or more computer-readable media. In one example, the memory/storage 810 includes volatile media (such as random access memory (RAM)) and/or nonvolatile media (such as read-only memory (ROM), Flash memory, optical disks, magnetic disks, and so forth). In another example, the memory/storage 810 includes fixed media (e.g., RAM, ROM, a fixed hard drive, and so on) and removable media (e.g., Flash memory, a removable hard drive, an optical disc, and so forth). The computer-readable media 804 is configurable in various ways, as described below.

Input/output interface(s) 806 are representative of functionality to allow a user to enter commands and information to the computer 104, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computer 104 is configurable in various ways to support user interaction, as further described below.

Various techniques are described in the general context of software, hardware elements, or program modules. Generally, such modules include routines, programs, objects, elements, components, data structures, and so forth that perform particular tasks or implement abstract data types. The terms “module,” “functionality,” and “component” as used herein generally represent software, firmware, hardware, or a combination thereof. The features of the techniques described herein are platform-independent, meaning that the techniques are implementable on various commercial computing platforms with various processors.

Implementations of the described modules and techniques are stored on or transmitted across some form of computer-readable media. For example, the computer-readable media includes a variety of media accessible to the computer 104. By way of example, and not limitation, computer-readable media includes “computer-readable storage media” and “computer-readable signal media.”

“Computer-readable storage media” refers to media and/or devices that enable persistent and/or non-transitory information storage in contrast to mere signal transmission, carrier waves, or signals per se. Thus, computer-readable storage media refers to non-signal-bearing media. The computer-readable storage media includes hardware such as volatile and non-volatile, removable and non-removable media, and/or storage devices implemented in a method or technology suitable for storage of information such as computer-readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer. “Computer-readable signal media” refers to a signal-bearing medium configured to transmit instructions to the hardware of the computer 104, such as via a network. Signal media typically embodies computer-readable instructions, data structures, program modules, or other data in a modulated data signal, such as carrier waves, data signals, or other transport mechanisms. Signal media also includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 808 and computer-readable media 804 are representative of modules, programmable device logic, and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware and hardware utilized to store instructions for execution, e.g., the computer-readable storage media described previously.

Combinations of the foregoing are also employable to implement various techniques described herein. Accordingly, software, hardware, or executable modules are implementable as instructions and/or logic embodied on some form of computer-readable storage media and/or by one or more hardware elements 808. For example, the computer 104 is configured to implement particular instructions and/or functions corresponding to the software and/or hardware modules. Accordingly, implementation of a module executable by the computer 104 as software is achieved at least partially in hardware, e.g., through computer-readable storage media and/or hardware elements 808 of the processor 802. The instructions and/or functions are executable/operable by one or more articles of manufacture (for example, one or more computers 104 and/or processors 802) to implement techniques, modules, and examples described herein.

The techniques described herein are supportable by various configurations of the computer 104 and are not limited to the specific examples of the techniques described herein. This functionality is also implementable entirely or partially through a distributed system, such as over a “cloud” 812, as described below.

Cloud 812 includes and/or represents a platform 814 for resources 816. The platform 814 abstracts the underlying functionality of hardware (e.g., servers) and software resources of the cloud 812. For example, resources 816 include applications and/or data utilized while computer processing is executed on servers remote from the computer 104. In some examples, the resources 816 also include services provided over the Internet and/or through a subscriber network, such as a cellular or Wi-Fi network.

Platform 814 abstracts the resources 816 and functions to connect the computer 104 with other computing devices. In some examples, the platform 814 also serves to abstract scaling of resources to provide a corresponding level of scale to encountered demand for the resources implemented via the platform. Accordingly, in an interconnected device embodiment, the implementation of functionality described herein is distributable throughout system 800. For example, the functionality is partially implementable on the computer 104 and via platform 814, which abstracts the functionality of cloud 812.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

1. A method, comprising:
receiving, by a processing device, a subject image depicting a subject person, a pose selection specifying a pose for the subject person, and target pose data associated with the pose selection;
determining, using a first machine-learning model and the subject image, measurements of the subject person, the measurements relatable to one or more dimensions described by the target pose data;
generating, using a second machine-learning model, a model of the subject person in the pose of the pose selection based on the measurements and the target pose data; and
displaying, by the processing device, a pose-transferred image depicting the subject person in the pose of the pose selection based on the model of the subject person.

2. The method of claim 1, further comprising:
receiving, by the processing device, a garment selection specifying a garment for the subject person;
determining, using a third machine-learning model, a fit of the garment on the subject person based on a garment image depicting the garment worn by another person and the measurements of the subject person; and
generating, by the processing device, the pose-transferred image, where the pose-transferred image portrays the subject person wearing the garment in the pose.

3. The method of claim 2, further comprising selecting, using a convolutional neural network, the garment image from a plurality of candidate images depicting the garment worn in different poses based on similarity between a pose depicted by the garment image and the pose specified by the pose selection, the similarity determined by the convolutional neural network.

4. The method of claim 1, wherein the pose selection is received via user input selecting the pose selection from a plurality of target poses, where each target pose of the plurality of target poses is associated with respective target pose data.

5. The method of claim 1, wherein the one or more dimensions described by the target pose data specify positions and orientations of body parts of a reference human model in the pose of the pose selection.

6. The method of claim 1, wherein the first machine-learning model is a parametric model that generates a mesh representing the subject person based on the measurements.

7. The method of claim 6, wherein the target pose data includes a mesh of a reference human model in the pose of the pose selection, and the second machine-learning model transforms the mesh representing the subject person based on the mesh of the reference human model.

8. The method of claim 7, wherein transforming the mesh representing the subject person based on the mesh of the reference human model includes maintaining a size and proportion of body parts represented by the mesh representing the subject person while adjusting a position or orientation of the body parts based on the mesh of the reference human model.

9. The method of claim 1, wherein the subject image of the subject person depicts the subject person wearing a garment, and the pose-transferred image depicts the subject person in the pose of the pose selection while wearing the garment.

10. The method of claim 1, further comprising determining, using a third machine-learning model, similarity between a pose of the subject person in the subject image and poses of a pose set, and outputting a recommendation for the pose selection based on the similarity.

11. The method of claim 1, wherein training data for the second machine-learning model includes pairs of images of persons in different poses to learn to transfer the poses between the persons.

12. The method of claim 1, wherein the model of the subject person in the pose of the pose selection is a mesh, and the pose-transferred image is generated using a generative adversarial neural network that synthesizes a portrayal of the subject person on the mesh.

13. A computing device, comprising:
a memory; and
a processor configured to:
receive a subject image depicting a subject person, a pose selection specifying a pose for the subject person, and target pose data associated with the pose selection;
determine, using a first machine-learning model and the subject image, measurements of the subject person, the measurements relatable to one or more dimensions described by the target pose data;
generate, using a second machine-learning model, a model of the subject person in the pose of the pose selection based on the measurements and the target pose data; and
display a pose-transferred image depicting the subject person in the pose of the pose selection based on the model of the subject person.

14. The computing device of claim 13, wherein the processor is configured to:
receive a garment selection specifying a garment for the subject person;
determine, using a third machine-learning model, a fit of the garment on the subject person based on a garment image depicting the garment worn by another person and the measurements of the subject person; and
generate the pose-transferred image, where the pose-transferred image portrays the subject person wearing the garment in the pose.

15. The computing device of claim 13, wherein the one or more dimensions described by the target pose data specify positions and orientations of body parts of a reference human model in the pose of the pose selection.

16. The computing device of claim 13, wherein the first machine-learning model is a parametric model that generates a mesh representing the subject person based on the measurements, the target pose data includes a mesh of a reference human model in the pose of the pose selection, and the second machine-learning model transforms the mesh representing the subject person based on the mesh of the reference human model.

17. The computing device of claim 13, wherein the processor is configured to:
determine, using a third machine-learning model, similarity between a pose of the subject person in the subject image and poses of a pose set, and outputting a recommendation for the pose selection based on the similarity.

18. The computing device of claim 13, wherein training data for the second machine-learning model includes pairs of images of persons in different poses to learn to transfer the poses between the persons.

19. The computing device of claim 13, wherein the model of the subject person in the pose of the pose selection is a mesh, and the pose-transferred image is generated using a generative adversarial neural network that synthesizes a portrayal of the subject person on the mesh.

20. One or more computer-readable storage media storing instructions that, responsive to execution by a processing device, causes the processing device to:
receive a subject image depicting a subject person, a pose selection specifying a pose for the subject person, and target pose data associated with the pose selection;
determine, using a first machine-learning model and the subject image, measurements of the subject person, the measurements relatable to one or more dimensions described by the target pose data;
generate, using a second machine-learning model, a model of the subject person in the pose of the pose selection based on the measurements and the target pose data; and
display a pose-transferred image depicting the subject person in the pose of the pose selection based on the model of the subject person.
